(19) United States
(12) Patent Application Publication
(10) Pub. No.: US 2013/0302489 A1
(43) Pub. Date: Nov. 14, 2013

(54) Airflow for banana cooling and ripening

(71) Applicant: Marvin Douglas Marlin, JR., Coral Gables, FL (US)

(72) Inventor: Marvin Douglas Marlin, JR., Coral Gables, FL (US)

(73) Assignee: Del Monte Fresh Produce Company, Coral Gables, FL (US)

(21) Appl. No.: 13/506,728

(22) Filed: May 11, 2012

(51) Int. Cl. B65D 5/42; A23B 7/00; B65D 5/00

(52) U.S. Cl. CPC B65D 5/4295; B65D 5/0015; A23B 7/00
USPC 426/419; 206/423; 206/386

(57) ABSTRACT

A stackable box configuration for shipping bananas is provided to improve airflow both vertically and horizontally through the boxes stacked in pallets without compromising the size of the boxes or pallets or the strength of the boxes.

### PRIORITY

This claims priority of PCT/US2010/002989 Nov, 17, 2010 and priority date from U.S. provisional application on Dec. 29, 2009.

### FIELD OF THE INVENTION

This invention relates to the field of packing, transporting and storing fresh fruit, especially bananas. More specifically the invention relates to a novel packaging system that improves banana cooling and ripening.

### BACKGROUND OF THE INVENTION

The standard 40 lb banana box configuration is what one typically calls a 4-row pack, starting with a row on the bottom running the lengths of the box. The rows are packed with the natural curve of the banana up (blossom tip down). On the first row, this creates a type of void along the bottom of the pack, over the gap in the bottom of the box. The next three layers are placed in he same fashion, over the bottom row, slightly off center as related to the end panel. The box is wider than the length of the cluster and allows space along the length of the box to ‘rotate’ each line of clusters down into the box. They are packed tightly with plastic bag and paper to be as compact as possible to allow the full weight to be contained.

The ends of the third row are typically up against the handhold, sometimes limiting its ability to function as an end vent. On the ship or in the container, with a vertical airflow, the only open areas exposed to the cool air are the gaps at the bottom of the lowest layer on the pallet and the top of the uppermost box on the pallet. In each case, the plastic and paper (tunnel pad) tend to restrict airflow as they block the gap top and bottom openings.

The boxes are typically packed during shipping as a unit on a 40×48 in. pallet with straps and corner boards. The pallets are then loaded directly next to each other in either shipping containers or the ship's hold with little or no air space between units. From the ship, they are delivered to specially designed ripening rooms and placed on the floor and racks within these rooms. A typical banana ripening room is designed to pull air through the complete unit horizontally from the 48 in. side of the pallet by exposing the pallet to a high pressure/low pressure environment. This is produced by a forced air system designed specifically to remove heat from ripening and maintain the bananas at an optimum temperature while exposing the fruit to an ethylene gas mixture to begin the ripening process.

In the palletized configuration, typical banana box side vents are rarely functional. The end vents function well in allowing air to the interior of the box (when the air is under pressure) and the handhold may or may not be blocked by fruit, introducing variability to the airflow, cooling and ripening process. After ripening, the boxes are typically delivered to retails stores where the boxes are stored in cool produce rooms that usually possess little more moving air than is required to keep temperatures low. Lack of high volume air and the heat generated by respiration of the banana forces the retail stores to re-stack the boxes and place them in what is called an ‘air-stack’. Even in this air-stack, standard banana box venting does not address the fact that heat rises and that the box needs to be vented properly to let the heat of respiration out unless the cover is removed to expose the fruit.

U.S. Pat. No. 5,121,877 provides one solution to the ventilation problem, and discloses containers adapted to be stacked in a pallet in a way that side surfaces of the containers are spaced apart in a manner to leave a channel between the adjacent containers for ventilating air to circulate and heat generated to be removed. The flaws in this solution are that: A) Due to the channel between the containers the pressurized air flow is NOT directed to the fruit inside, but subsequently along outside of the container (made of corrugated, a natural insulator due to its multi-wall construction) and B) The size of the container is smaller due to design, reducing the available internal “cube” of the container and thereby limiting the ability to pack the actual 40 plus pounds of fruit in the tropics to deliver the 40 lb minimum weight declared on the container.

### SUMMARY OF THE INVENTION

The instant invention solves the above-described flaws of the current practices.

Accordingly, an object of this invention is to improve the ability of the standard banana box to allow increased airflow through the box in both vertical and horizontal directions, cooling the fruit faster (using less energy per pound).

Another object of the instant invention is to provide a banana box that allows increased airflow in both vertical and horizontal directions forcing the air flow to mix within the container in such a fashion so as to improve the color-break during ripening and even out the color during the ripening of the fruit in a tightly packed box.

Yet another object of the instant invention is to provide banana box where vertical component of the vents is designed to provide the heat trapped in the boxes a better route to escape in both moving and nonmoving air, and thereby improving cooling, especially from the “core” or center section of the palletized load where heat build-up is greatest.

The objects can be achieved by providing a method comprising the steps of:

a) providing stackable banana packs consisting of a box and a lid;
said box having rectangular bottom panel with an open center, two side panels secured to opposite sides of the bottom panel along side fold lines, and two end panels secured to opposite ends of the bottom panel along end fold lines;
   the end panels having two linearly positioned openings in their lower portions and a notch in center of their upper edges;
   the end panels further having an aperture in center of the end fold line, said aperture extending to the bottom panel, whereby the aperture is both vertical and horizontal ;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned openings in their lower portions and a notch in center of their lower edges;
the end panels further having an aperture in center of the end score line, said aperture extending to the top panel, whereby the apertures are both vertical and horizontal;
the side panels having two notches in their lower edges and two apertures (in the side score lines, said apertures extending to the top panel, whereby the apertures are both vertical and horizontal;

b. packing bananas into the box in rows with banana curvature upwards;

c. inserting the lid on the box, whereby the openings in the end panels of the box and the openings of the lid are coinciding, the notches of the box side panels coincide with the apertures of the lid side panels, and the notches of the box end panels coincide with the apertures of the lid end panels, and the notches of the lid end panels coincide with the apertures of the box end panels;

d. arranging a first layer of boxes side by side by assuring that the apertures of the lid score lines of boxes adjacent to each other merge together;

e. arranging further layers of boxes on top of the first layer by assuring that apertures of the lid end score lines of a lower box layer merge with the apertures of the box end fold lines of boxes in upper layer, thereby forming a horizontal tunnel for air to move through the end apertures; and by assuring that the lid side score line apertures in the first layer merge with the box side fold line apertures of the upper layer, thereby forming vertical tunnels for air to move through the side apertures;

f. repeating steps d and e to form pallets of desired size;

g. arranging rows of pallets desired size by leaving a passage between the rows; and

h. assembling a fan at end of the passage, said fan pulling air through the pallets via the horizontal and vertical tunnels formed in step e), removing heat of the air and returning cooled air to room.

The objects may also be achieved by providing an improved stackable pack for cooling and ripening banana, said pack consisting of a box and a lid;
said box having rectangular bottom panel with an open center, two side panels secured to opposite sides of the bottom panel along side fold lines, and two end panels secured to opposite ends of the bottom panel along end fold lines;
   the end panels having two linearly positioned openings in their lower portions and a notch in center of their upper edges;
   the end panels further having an aperture in center of the end fold line, said aperture extending to the bottom panel, whereby the aperture is both vertical and horizontal;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned opening in their lower portions and a notch in center of their lower edges;
the end panels further having an aperture in center of the end score line, said aperture extending to the top panel, whereby the apertures are both vertical and horizontal;
the side panels having two notches in their lower edges and two apertures in the side score lines, said apertures extending to the top panel, whereby the apertures are both vertical and horizontal;
said pack being assembled by inserting the lid on the box, whereby the openings in the end panels of the box and the openings of the lid are coinciding, the notches of the box side panels coincide with the apertures of the lid side panels, and the notches of the box end panels coincide with the apertures of the lid end panels, and the notches of the lid end panels coincide with the apertures of the box end panels;
said pack further being packable in pallets where apertures of the lid end score lines of a lower pack layer merge with the apertures of the box end fold lines of pack in upper layer, thereby forming a horizontal tunnel for air to move through the end apertures, and the lid side score line apertures in a lower pack layer merge with the box side fold line apertures of the upper layer, thereby forming vertical tunnels for air to move through the side apertures.

According to other embodiments of the invention, the pack may have a handhold opening in the end panels of the box and the lid. Instead of one aperture in the middle of the end score line, the pack may have two apertures extending to top panel and providing horizontal and vertical ventilation path through the pallet. According to further embodiments the pack may lack the openings in the end panel. Instead of having one aperture in the middle of the end score line extending to the top panel, the pack may have one aperture in middle of the end score line on the top panel without extension to the end panel.

### BRIEF DESCRIPTION OF THE DRAWINGS

FIG. 1. Illustrates prior art pack used for shipping fruits such as bananas.

FIG. 2 Illustrates one preferred embodiment of the pack according to this invention.

FIG. 3 illustrates another preferred embodiment of the pack according to this invention.

FIG. 4 illustrates yet another preferred embodiment of the pack according to this invention.

FIG. 5. Illustrates banana packs as described in FIG. 2 arraigned in a pallet.

FIG. 6. Illustrates banana packs as described in FIG. 3 arraigned in a pallet.

FIGS. 7A, B and C. Illustrates the horizontal and vertical air movement through the packs of various embodiments arranged in pallet.

FIG. 8. Illustrates faster cooling rates of boxes of this disclosure as compared to the cooling rates of traditional boxes.

### DETAILED DESCRIPTION OF THE INVENTION

This disclosure provides a unique score line vent (vent placed on the right angle fold of a score) pattern for the standard 40 1b banana box. The side vents are typically blocked by product and plastic bags used to pack bananas and the handholds on the end are sometimes blocked by product due to their location in relationship to the manner of packing. This disclosure provides a solution to the existing problems.

To that end, with studies performed on airflow models using smoke trails to determine the best patterns, the side vents were eliminated and moved to the top and bottom of the box on the length panel. The vents were extended in the horizontal direction to allow full access to the interior of the box. These vents were placed in a position that would NOT be blocked by product. They were also made large enough to allow for mis-alignment in the stack as the top and bottom vents are designed align vertically box-to-box and increase the opportunity for airflow by offering a larger, aligned aperture.

On the end panel, the hand-hold was eliminated, reducing the opportunity for on-again/off-again venting based on the random pack. A large matching top and bottom scoreline/hand-hold end vent aperture was designed to allow air to enter the package at the precise point where it would NOT be blocked by product or bag. The top and bottom configuration was designed to offer a larger opportunity for air entrance and mitigate the effects of misalignment for the stack of packed cartons. This entrance allows more air to enter and mix within the container with less obstruction due to its size and location.

One skilled in the art would realize that the invention of this disclosure may be reached by variation that could include size, shape, and number of vents depending on the size of the carton. For standard, symmetrical patterns, location is of minor importance due to the fact that all boxes are “soldiered” or stacked side-by-side and end-to-end with equal mating of sides and ends. For asymmetrical patterns such as used for the “common footprint (40×60) design, a unique venting pattern is required for the vents to line up from box-to-box, allowing horizontal airflow. This is typically called the 10 cm rule as vents are placed in the center of the 60 cm panel and 10 cms from the corners on the other panels allowing them to line up the vents from like boxes on a pallet. The number of vents is configured depending on the product and size of the box.

Advantages of the Invention over Prior Practice: A comparison of many banana box vent patterns in the marketplace will show little difference in the approach to venting. The location of vents on the side panels were due to the fact that most individuals familiar with produce simply expect vent panels in the side of boxes. The actual locations are generally not a consideration and the fact that these vents are almost non-functional due to the tight side by side loading of pallets was not considered. The hand-hold locations are similar and study shows great variability in location in the top ⅓ of the end panel. This variability leads to uneven airflow depending on whether or not the hand-hold is blocked by the product as introduced by the packer.

The score line vents are always open to allow introduction of airflow into a box. This is due to the fact that a rounded fruit cannot fit tightly into the right angle corner of the score line and therefore cannot block the vent. The improvement was to create large top and bottom score line/hand-hold /end-vent configurations specifically designed to let increased airflow into the banana box during a typical pressure cooling situation and offer the opportunity for rapid heat removal and exposure to the ethylene gas during ripening. The large vents are also designed to function as hand-holds during palletization and de-stacking.

The score line vents, due to their vertical opening, also allow the heat generated within a ripened box to evacuate vertically when not exposed to airflow, something not offered by standard sidewall vents. This improvement is designed to work for end panel and length panel as well. This will benefit boxes being stored in the back rooms at retail as the product is being prepared for the retail sales area. It will also have a positive effect upon open hold shipping as heat retained in the boxes will also have a clearer escape route through the vertically aligned score line vents.

Reference is now made in detail to the presently preferred embodiment, examples of which are illustrated in the accompanying figures, wherein numerals indicate the elements as referred below.

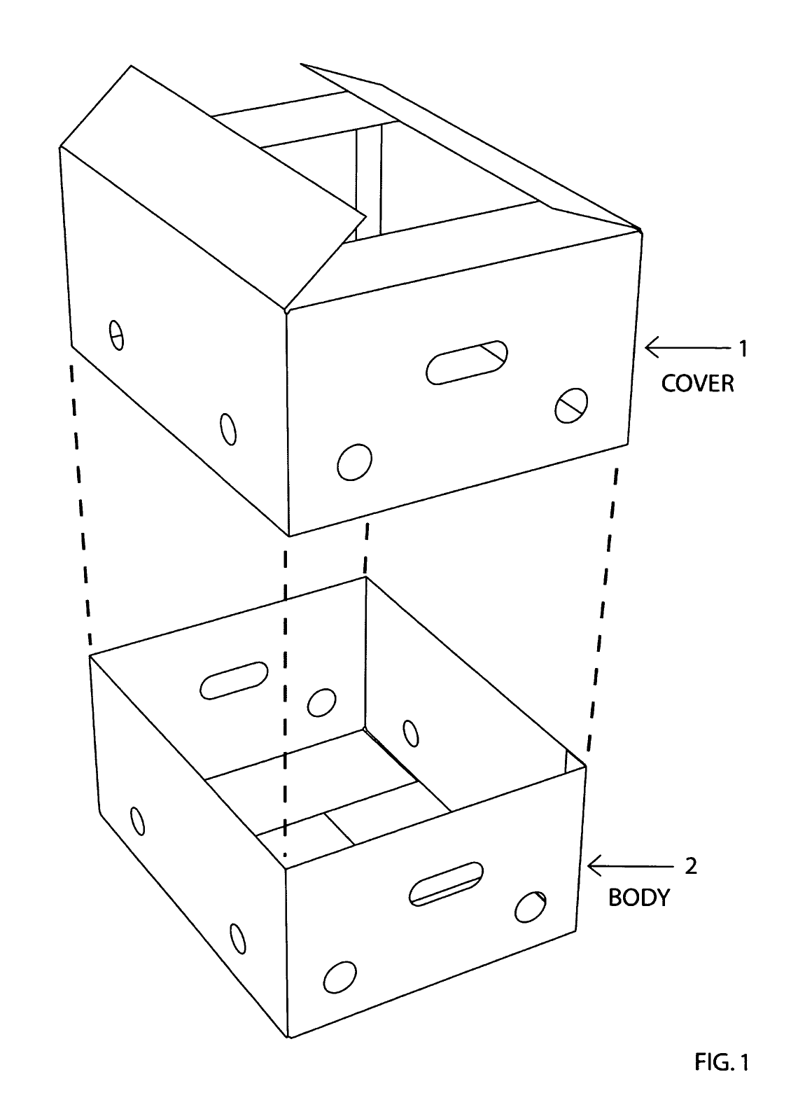

FIG. 1 illustrates a prior art container for storing and transporting fruits. The container comprises a box portion (2) and a lid portion (1) where the box portion slids into the lid portion to form the container.

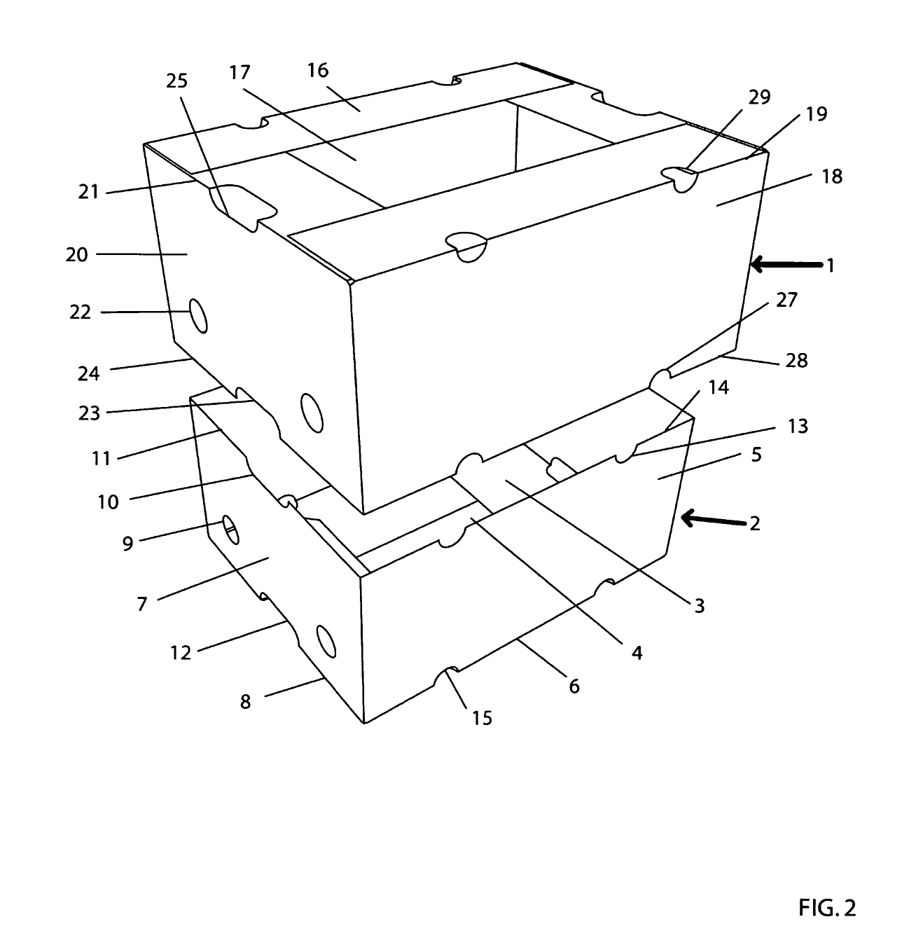

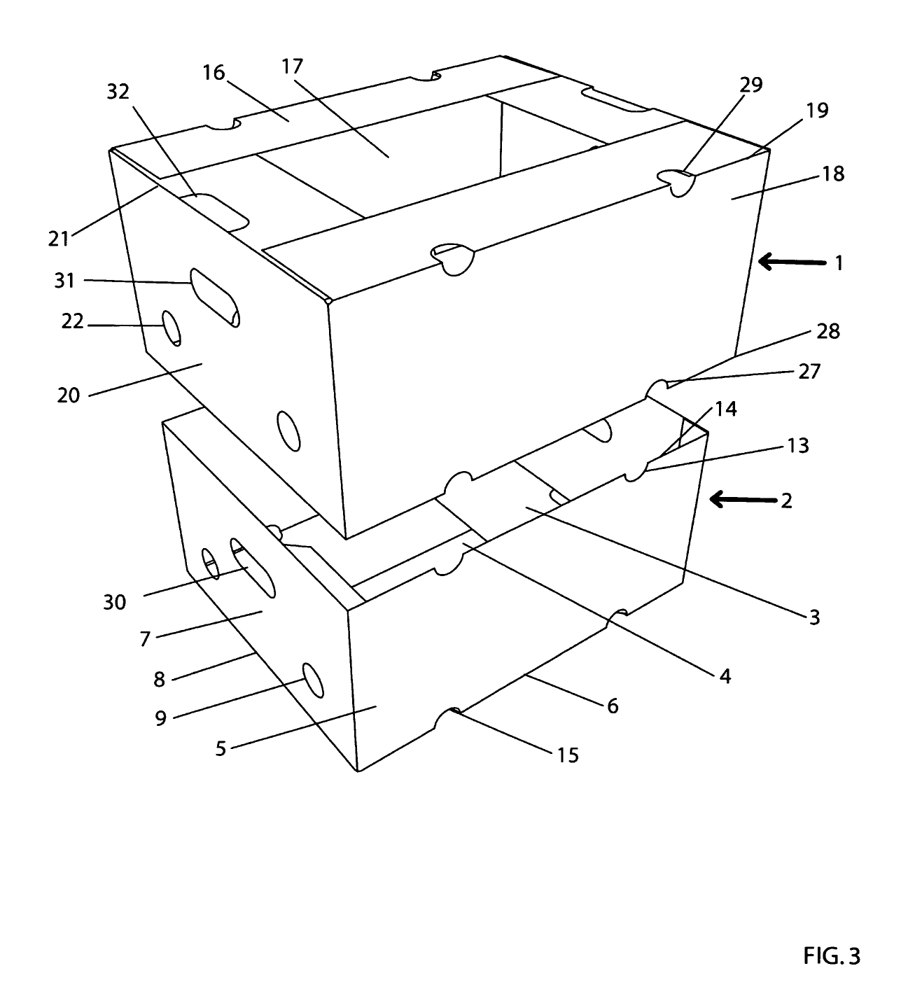

FIG. 2 illustrates one preferred embodiment of the pack according to this invention. The pack consists of a box (2) and a lid (1). The box comprises a rectangular bottom panel (3) with an open center (4), two side panels (5) secured to opposite sides of the bottom panel along side fold lines (6), and two end panels (7) secured to opposite ends of the bottom panel along end fold lines (8). The end panels have two linearly positioned openings (9) in their lower portions and a notch (10) in center of their upper edges (11). The end panels have further an aperture (12) in center of the end fold line, said aperture extending to the bottom panel, whereby the aperture is both vertical and horizontal. The side panels have two notches (13) in their upper edges (14) and two apertures (15) in the side fold lines, said apertures extending to the bottom panel, whereby the apertures are both vertical and horizontal. The lid has a rectangular top panel (16) with an open center (17), two side panels (18) secured to opposite ends of the top panel along side score lines (19), and two end panels (20) secured to opposite ends of the top panel along end score lines (21). The end panels have two linearly positioned openings (22) in their lower portion and a notch (23) in center of their lower edges (24). The end panels have also an aperture (25) in center of the end score line, said aperture extending to the top panel, whereby the apertures are both vertical and horizontal. The side panels have two notches (27) in their lower edges (28) and two apertures (29) in the side score lines, said apertures extending to the top panel, whereby the apertures are both vertical and horizontal.

FIG. 3 illustrates another preferred embodiment of the pack according to this invention. The pack consists of a box (2) and a lid (1). The box comprises a rectangular bottom panel (3) with an open center (4), two side panels (5) secured to opposite sides of the bottom panel along side fold lines (6), and two end panels (7) secured to opposite ends of the bottom panel along end fold lines (8). The end panels have two linearly positioned openings (9) in their lower portions. The end panels have further a handhold opening (30). The side panels have two notches (13) in their upper edges (14) and two apertures (15) in the side fold lines, said apertures extending to the bottom panel, whereby the apertures are both vertical and horizontal. The lid has a rectangular top panel (16) with an open center (17), two side panels (18) secured to opposite ends of the top panel along side score lines (19), and two end panels (20) secured to opposite ends of the top panel along end score lines (21). The end panels have two linearly positioned openings (22) in their lower portion. The end panels have further a handhold opening (31) and the top panel has an aperture (32) in center of the end score line. The side panels have two notches (27) in their lower edges (28) and two apertures (29) in the side score lines, said apertures extending to the top panel, whereby the apertures are both vertical and horizontal.

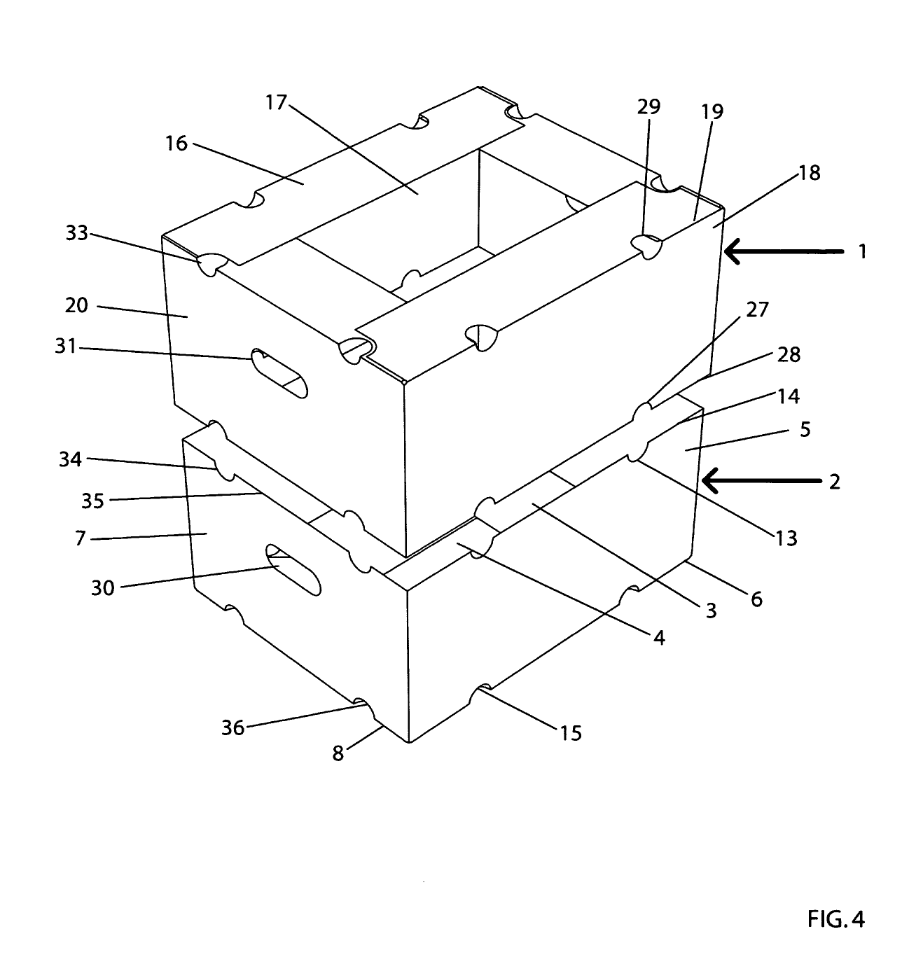

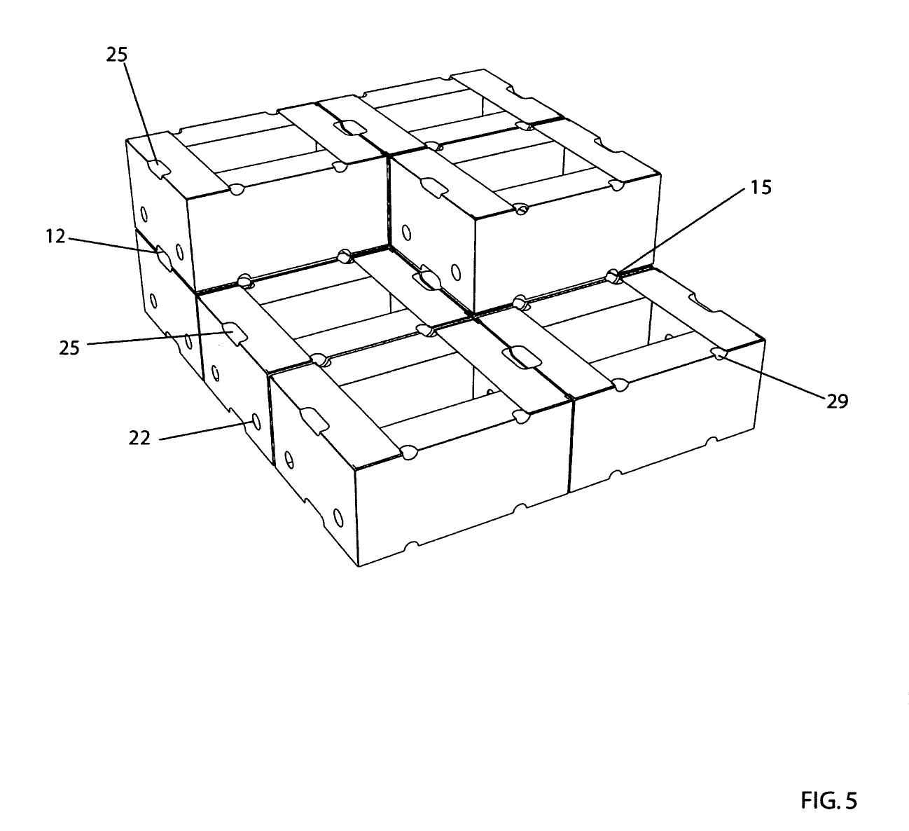

FIG. 4 illustrates yet another preferred embodiment of the pack according to this invention. The pack consists of a box (2) and a lid (1). The box comprises a rectangular bottom panel (3) with an open center (4), two side panels (5) secured to opposite sides of the bottom panel along side fold lines (6), and two end panels (7) secured to opposite ends of the bottom panel along end fold lines (8). The end panels have further a handhold opening (30). The end panels have also two notches (34) in their upper edges (35). The side panels have two notches (13) in their upper edges (14) and two apertures (15) in the side fold lines, said apertures extending to the bottom panel, whereby the apertures are both vertical and horizontal. The end panel has two notches (36) along the end fold line, said apertures extending to the bottom panel, whereby the apertures are both vertical and horizontal. The lid has a rectangular top panel (16) with an open center (17), two side panels (18) secured to opposite ends of the top panel along side score lines (19), and two end panels (20) secured to opposite ends of the top panel along end score lines (21). The end panels have a handhold opening (31) and two apertures (33) at the end score line. The apertures extend to the top panel, whereby the apertures are both vertical and horizontal. The side panels have two notches (27) in their lower edges (28) and two apertures (29) in the side score lines, said apertures extending to the top panel, whereby the apertures are both vertical and horizontal.

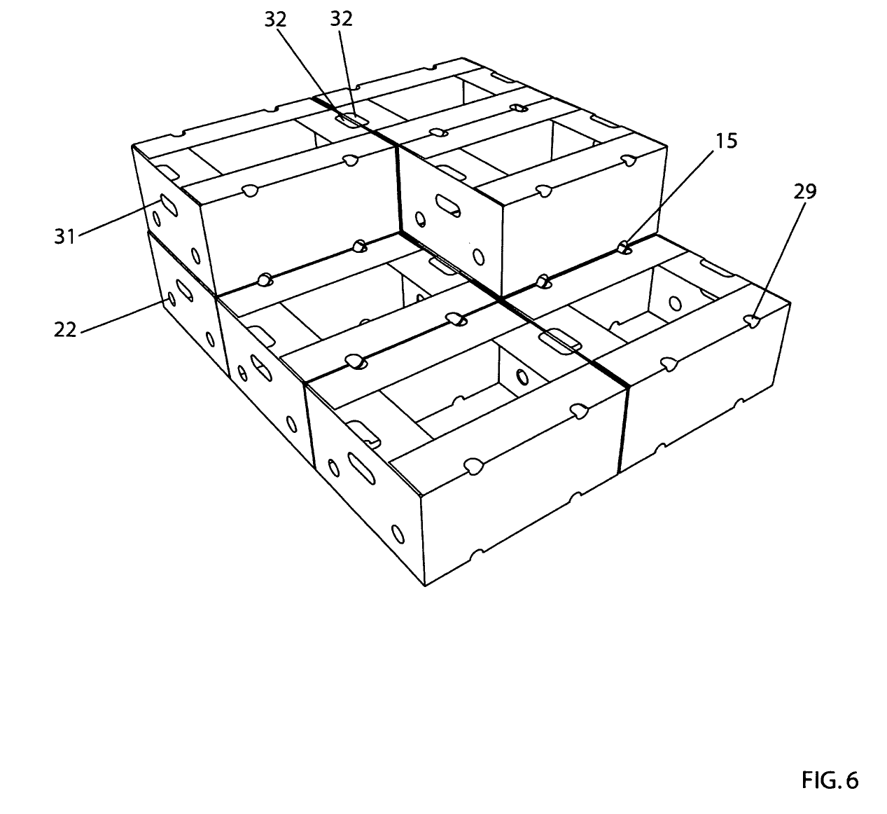

FIG. 5 illustrates the packs according to one preferred embodiment of this disclosure where the packs have been arraigned into a pallet. The pallet is so arranged that the apertures in the end panel/top panel (25) of a lower layer pack coincide with the aperture in the end panel/bottom panel (12) of an upper layer pack, thereby forming a vertical and a horizontal venting channel through the pallet. Furthermore, the apertures of the side panel/top panel (29) of a lower layer pack coincide with the aperture in the side panel/bottom panel aperture (15) of the upper layer pack, thereby also forming a vertical and horizontal venting channel through the pallet. Even further, the side panel/top panel apertures (29) of adjacent packs in same layer coincide with each other as well as the side panel/bottom panel apertures (15) of adjacent packs in same layer coincide with each other, thereby forming a horizontal air venting channel through the pallet. Furthermore, the openings in the end panels (22) of adjacent packs in same layer coincide with each other, forming a horizontal air-venting channel.

FIG. 6 illustrates the packs according to another preferred embodiment of this disclosure where the packs have been arraigned into a pallet. The pallet is so arranged that the top panel apertures (32) apertures of adjacent packs coincide with each other. Furthermore, the handhold openings (31) of adjacent packs coincide with each other, thereby forming a horizontal air vent channel through the pallet. Even further, the apertures of the side panel/top panel (29) of a lower layer pack coincide with the aperture in the side panel/bottom panel aperture (15) of the upper layer pack, thereby forming a horizontal and vertical air vent channel through the pallet. Even further, the end panel apertures (22) of adjacent packs coincide with each other forming a horizontal air vent channel through the pallet.

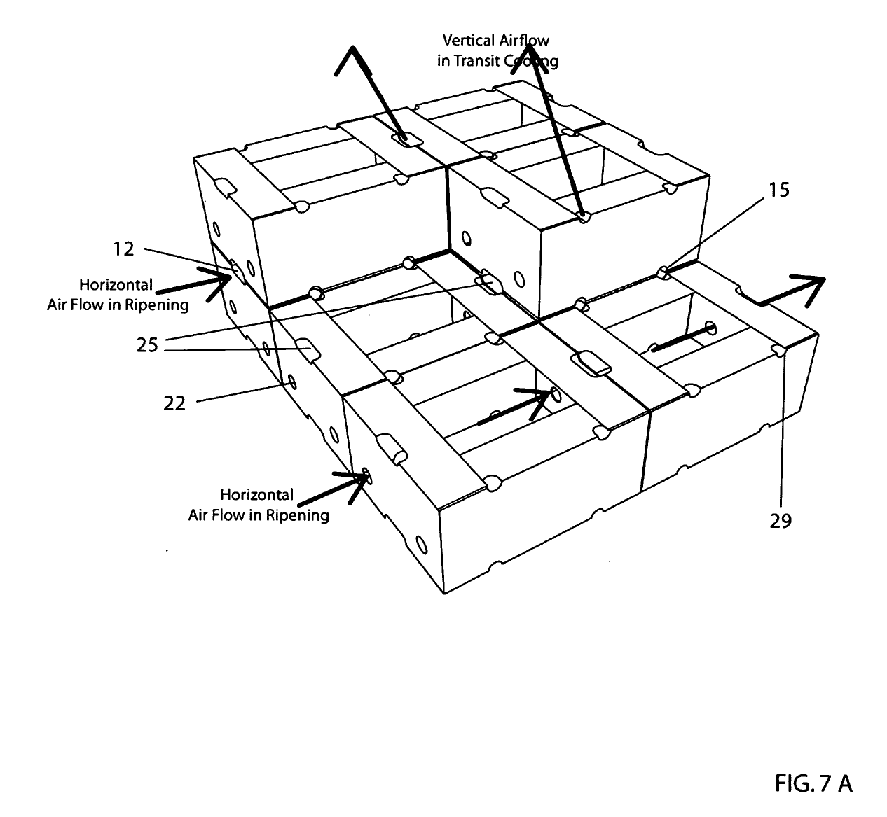

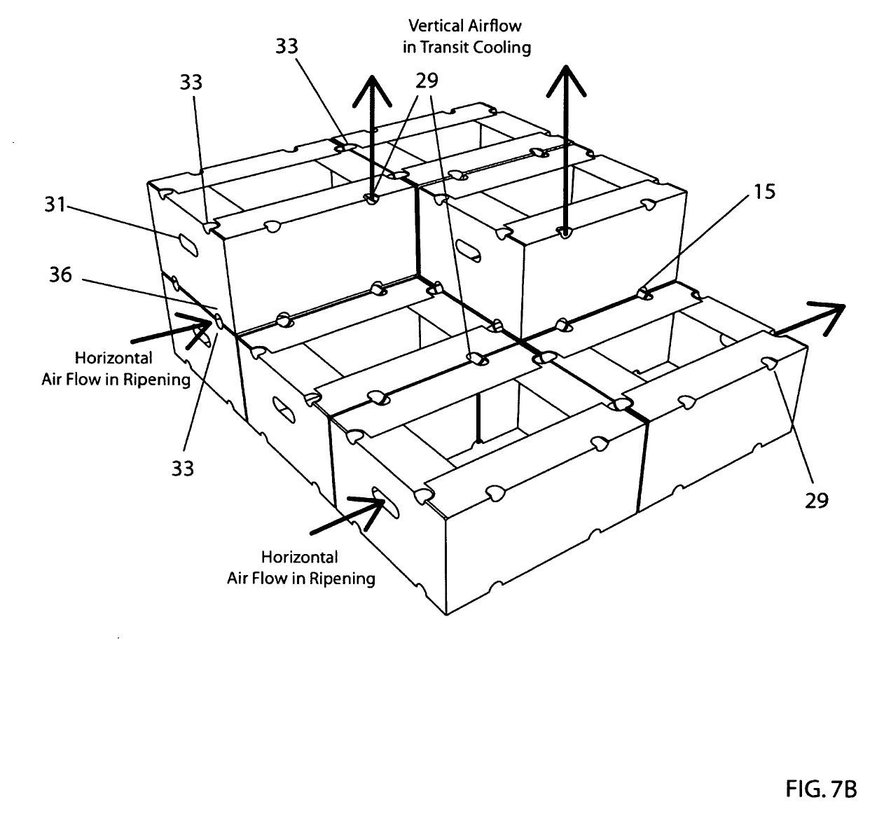

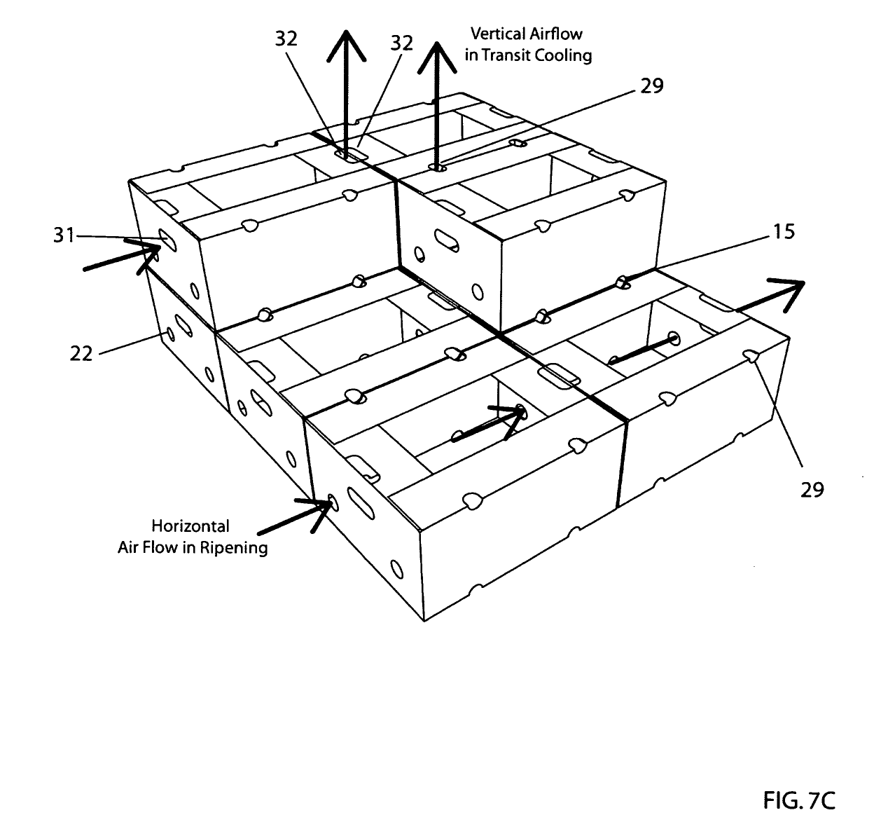

FIG. 7A illustrate the horizontal and vertical movements of the airflow through the packs as a result of venting tunnels created by arranging a first layer of boxes side by side and one over another and assuring the apertures in the end panel/top panel (25) of a lower layer pack coincide with the aperture in the end panel/bottom panel (12) of an upper layer pack, thereby forming a vertical and a horizontal venting channel through the pallet. Furthermore, the apertures of the side panel/top panel (29) of a lower layer pack coincide with the aperture in the side panel/bottom panel aperture (15) of the upper layer pack, thereby also forming a vertical and horizontal venting channel through the pallet. Even further, the side panel/top panel apertures (29) of adjacent packs in same layer coincide with each other as well as the side panel/bottom panel apertures (15) of adjacent packs in same layer coincide with each other, thereby forming a horizontal air venting channel through the pallet. Furthermore, the openings in the end panels (22) of adjacent packs in same layer coincide with each other, forming a horizontal air-venting channel.

FIG. 7B illustrates the horizontal and vertical movements of the airflow through the packs as a result of venting tunnels created by arranging a first layer of boxes side by side and one over another and assuring that the apertures (33) of adjacent packs coincide with each other. Furthermore, the handhold openings (31) of adjacent packs coincide with each other, thereby forming a horizontal air vent channel through the pallet. Even further the apertures of the side panel/top panel (29) of a lower layer pack coincide with the aperture in the side panel/bottom panel aperture (15) of the upper layer pack, thereby forming a horizontal and vertical air vent channel through the pallet. Even further the apertures (33) of lower layer boxes coincide with bottom end fold line apertures (36) of upper layer boxes forming a horizontal and vertical vent channel through the pallet.

FIG. 7C Illustrate the horizontal and vertical movements of the airflow through the packs as a result of venting tunnels created by arranging a first layer of boxes side by side and one over another and assuring that the top panel apertures (32) apertures of adjacent packs coincide with each other. Furthermore, the handhold openings (31) of adjacent packs coincide with each other, thereby forming a horizontal air vent channel through the pallet. Even further, the apertures of the side panel/top panel (29) of a lower layer pack coincide with the aperture in the side panel/bottom panel aperture (15) of the upper layer pack, thereby forming a horizontal and vertical air vent channel through the pallet. Even further, the end panel apertures (22) of adjacent packs coincide with each other forming a horizontal air vent channel through the pallet.

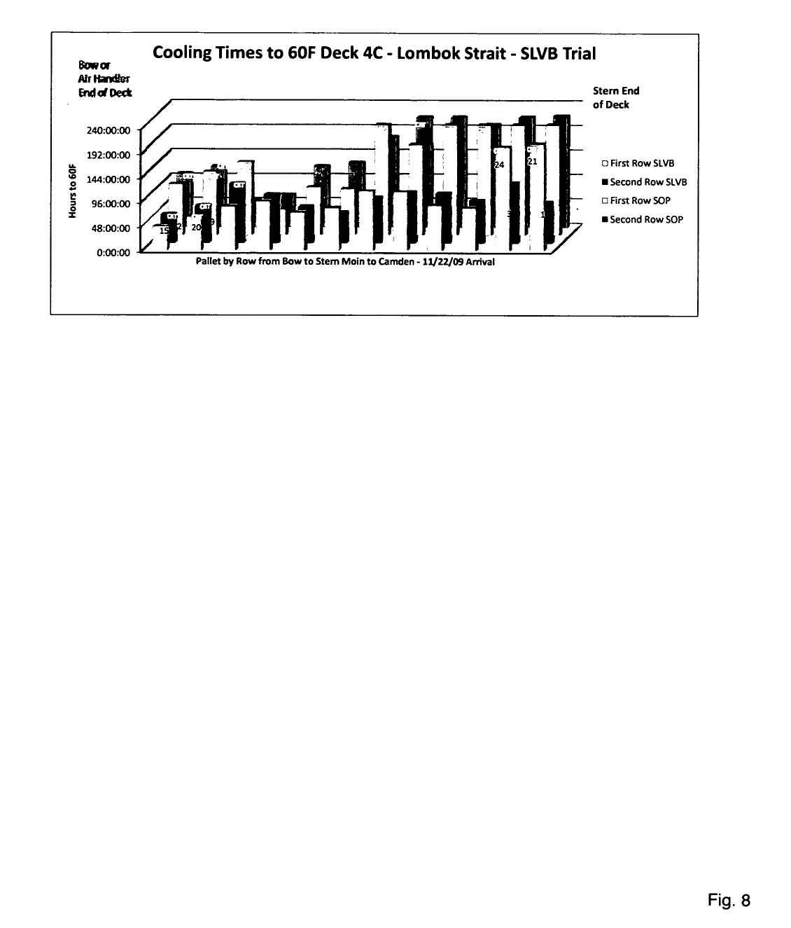

FIG. 8 illustrates faster cooling rates of boxes of this disclosure as compared to the cooling rates of traditional boxes

### EXAMPLE 1

On Nov. 15, 2009, a large number of banana boxes (Scoreline Vent Boxes; SLVB) according to this disclosure were packed for shipment to Camden, N.J. The test comprised of 364 pallets loaded in 4C on the Lombok Strait. One half of the deck, from bow to stern was comprised of standard banana packaging (SOP) and the other half of the deck held the trial SLVB carton. All was commercial product.

For the test, clusters of four pallets containing temperature recorders were placed in specific locations throughout the deck. There were a total of 48 pallets with both a standard DeltaTRAK temperature recorder and an Evidencia RFID temperature recorder in each pallet. The recorders were placed in a box five layers up in the center of the three stacks on the 48 in side of the pallet. 11 pulp recorders were also included to determine how the temperature of the fruit differed from the temperature of the recorders that were placed in the boxes. The data points show the time that it took an individual recorder to reach 60 F, a critical milestone in the process of shipping bananas. FIGS. 4 and 5 show side view of the pallets. The SLVB boxes of this disclosure are packed in pallets where the score line vents of the side panels are aligned to form venting route for air through the boxes. FIG. 3 shows end panels and side panels of a pallet. Score line vents in the end panels are aligned to form horizontal/vertical venting routes for the air through the boxes and the score line vents in the side panels are aligned to form vertical venting routs for the air through the boxes. Airflow through the boxes is illustrated in FIG. 6. FIG. 8 shows a score line vent in a side panel. Temperature measurements were recorded as follows:
1. A common start time of Nov. 15, 2009-14:00 was used to simplify the analysis. The pack-out at the farms (for the temp sensor loads) went from 08:00 to 14:00 on that Sunday.
2. If a recorder failed to reach 60 F by the time it was stopped on Tuesday Nov. 24, 2009, a common end time of Nov. 24, 2009-13:08 hours was assigned. The retrieval of the sensors lasted from 12:00 to 20:00 on that date in Camden.

FIG. 8 illustrates the recorded cooling times of boxes according to this disclosure and of regular boxes. The data points show the time that it took an individual recorder to cool to 60 F. It can be seen that the boxes of this disclosure had a shorter cooling time overall.

In summary, it is evident that the SLVB design cooled faster than the SOP containers except at the far end of the deck, away from the refrigeration units where neither did well due to airflow issues with the deck itself. On average, the SLVB design cools approximately 30% faster than the SOP box. In addition the SLVB box according to this disclosure shows a slight increase in box strength that may be related to the redesigned hand-hold locations on the ends of the design. Ripening tests have shown uniform color break and even cooling in all experiments to date.

What is claimed is:

1. A method to improve airflow for banana cooling and ripening, said method comprising the steps of:
a) providing stackable banana packs consisting of a box and a lid;
said box having a rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a notch in center of their upper edges;
the end panels further having an aperture in center of the end fold line, said aperture extending to the bottom panel, whereby the aperture is both vertical and horizontal;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned openings in their lower portions and a notch in center of their lower edges;
the end panels further having an aperture in center of the end score line, said aperture extending to the top panel, whereby the apertures are both vertical and horizontal;
the side panels having two notches in their lower edges and two apertures in the side score lines, said apertures extending to the top panel, whereby the apertures are both vertical and horizontal;
b. packing bananas into the box in rows with banana curvature upwards;
c. inserting the lid on the box, whereby the openings in the end panels of the box and the openings of the end panel of the lid are coinciding, the notches of the box side panels coincide with the apertures of the lid side panels, and the notches of the box end panels coincide with the apertures of the lid end panels, and the notches of the lid end panels coincide with the apertures of the box end panels;
d. arranging a first layer of packs side by side by assuring that the apertures of the lid side score lines of boxes adjacent to each other merge together, and the apertures of the lid end score lines of boxes adjacent to each other merge together;
e. arranging further layers of packs on top of the first layer by assuring that apertures of the lid end score lines of a lower pack layer merge with the apertures of the box end fold lines of packs in upper layer, thereby forming a horizontal tunnel for air to move through the end apertures;
and by assuring that the lid side score line apertures in the first layer merge with the side fold line apertures of the packs in the upper layer, thereby forming vertical tunnels for air to move through the side apertures;
f. repeating steps d and e to form pallets of desired size;
g. arranging rows of pallets of desired size by leaving a passage between the rows; and
h. assembling a fan at end of the passage, said fan pulling air through the pallets via the horizontal and vertical tunnels formed in step e), and removing heat of the air and returning cooled air to room.

2. A method to improve airflow for banana cooling and ripening, said method comprising the steps of:
a) providing stackable banana packs consisting of a box and a lid;
said box having a rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned openings in their lower portions and a handhold opening;
the top panel having an aperture in center of the end score line;
the side panels having two notches in their lower edges and two apertures in the side score lines, said apertures extending to the top panel, whereby the apertures are both vertical and horizontal;
b. packing bananas into the box in rows with banana curvature upwards;
c. inserting the lid on the box, whereby the openings in the end panels of the box and the openings of the end panel of the lid are coinciding, the notches of the box side panels coincide with the apertures of the lid side panels, and the handhold openings of the box end panels coincide with the handhold openings of the lid end panels;
d. arranging a first layer of packs side by side by assuring that the apertures of the lid side score lines of packs adjacent to each other merge together, and the handhold openings of packs adjacent to each other merge together;
e. arranging further layers of packs on top of the first layer by assuring that the lid side score line apertures in the first layer merge with the side fold line apertures of the packs in the upper layer, thereby forming vertical tunnels for air to move through the side apertures;
f. repeating steps d and e to form pallets of desired size;
g. arranging rows of pallets of desired size by leaving a passage between the rows; and
h. assembling a fan at end of the passage, said fan pulling air through the pallets via the horizontal and vertical tunnels formed in step e), and removing heat of the air and returning cooled air to room

3. A method to improve airflow for banana cooling and ripening, said method comprising the steps of:
a) providing stackable banana packs consisting of a box and a lid;
said box having a rectangular bottom panel with an open center, two side panels secured to opposite sides of the bottom panel along side fold lines, and two end panels secured to opposite ends of the bottom panel along end fold lines;
the end panels having two notches in their upper edges and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two apertures at the end score line, said apertures extending to the top panels, whereby the apertures are both vertical and horizontal;
the end panels having also a handhold opening;
the side panels having two notches in their lower edges and two apertures in the side score lines, said apertures extending to the top panel, whereby the apertures are both vertical and horizontal;
b. packing bananas into the box in rows with banana curvature upwards;
c. inserting the lid on the box, whereby the notches of the box side panels coincide with the apertures of the lid side panels, and the handhold openings of the box end panels coincide with the handhold openings of the lid end panels, and the notices of the lid end panel coincide with the apertures of the box end panel;
d. arranging a first layer of packs side by side by assuring that the apertures of the lid side score lines of packs adjacent to each other merge together, the apertures of the end panel score lines of packs adjacent to each other merge together, and the handhold openings of packs adjacent to each other merge together;
e. arranging further layers of packs on top of the first layer by assuring that the lid side score line apertures in the first layer merge with the side fold line apertures of the packs in the upper layer, thereby forming vertical tunnels for air to move through the side apertures;
f. repeating steps d and e to form pallets of desired size;
g. arranging rows of pallets of desired size by leaving a passage between the rows; and
h. assembling a fan at end of the passage, said fan pulling air through the pallets via the horizontal and vertical tunnels formed in step e), and removing heat of the air and returning cooled air to room

4. An improved stackable pack for cooling and ripening banana, said pack consisting of a box and a lid;
said box having rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a notch in center of their upper edges;
the end panels further having an aperture in center of the end fold line, said aperture extending to the bottom panel, whereby the aperture is both vertical and horizontal;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned opening in their lower portions and a notch in center of their lower edges;
the end panels further having an aperture in center of the end score line, said aperture extending to the top panel, whereby the apertures are both vertical and horizontal;
the side panels having two notches in their lower edges and two apertures in the side score lines, said apertures extending to the top panel, whereby the apertures are both vertical and horizontal;
said pack being assembled by inserting the lid on the box, whereby the openings in the end panels of the box and the openings of the lid are coinciding, the notches of the box side panels coincide with the apertures of the lid side panels, and the notches of the box end panels coincide with the apertures of the lid end panels, and the notches of the lid end panels coincide with the apertures of the box end panels;
said pack further being packable in pallets, where apertures of the lid end score lines of a lower pack layer merge with the apertures of the box end fold lines of pack in upper layer, thereby forming a horizontal tunnel for air to move through the end apertures, and the lid side score line apertures in a lower pack layer merge with the box side fold line apertures of the upper layer, thereby forming vertical tunnels for air to move through the side apertures.

5. An improved stackable pack for cooling and ripening banana, said pack consisting of a box and a lid:
said box having a rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned openings in their lower portions and a handhold opening;
the top panel having an aperture in center of the end score line;
the side panels having two notches in their lower edges and two apertures in the side score lines, said apertures extending to the top panel, whereby the apertures are both vertical and horizontal;
said pack being assembled by inserting the lid on the box, whereby the openings in the end panels of the box and the openings of the end panel of the lid are coinciding, the notches of the box side panels coincide with the apertures of the lid side panels, and the handhold openings of the box end panels coincide with the handhold openings of the lid end panels;
said pack further being packable in pallets, where apertures of the box side score lines of packs in an upper layer merge with apertures of lid side core line in lower layer, thereby forming a vertical and a horizontal tunnel for air to move through the pallet.

6. An improved stackable pack for cooling and ripening banana, said pack consisting of a box and a lid:
said box having a rectangular bottom panel with an open center, two side panels secured to opposite sides of the bottom panel along side fold lines, and two end panels secured to opposite ends of the bottom panel along end fold lines;
the end panels having two notches in their upper edges and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two apertures at the end score line, said apertures extending to the top panels, whereby the apertures are both vertical and horizontal;
the end panels having also a handhold opening;
the side panels having two notches in their lower edges and two apertures in the side score lines, said apertures extending to the top panel, whereby the apertures are both vertical and horizontal;
said pack being assembled by inserting the lid on the box, whereby the notches of the box side panels coincide with the apertures of the lid side panels, and the handhold openings of the box end panels coincide with the handhold openings of the lid end panels, and the notices of the lid end panel coincide with the apertures of the box end panel;
said pack further being packable in pallets, where apertures of the box side score lines of packs in an upper layer merge with apertures of lid side core line in lower layer, and the apertures of the box end score lines of packs in an upper layer merge with apertures of lide end score line in lower layer thereby forming a vertical and a horizontal tunnels for air to move through the pallet.

7. An improved pallet of banana packs for cooling and ripening bananas, comprising a desired number of packs, said packs consisting of a box and a lid;
said box having rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a notch in center of their upper edges;
the end panels further having an aperture in center of the end fold line, said aperture extending to the bottom panel, whereby the aperture is both vertical and horizontal;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned opening in their lower portions and a notch in center of their lower edges;
the end panels further having an aperture in center of the end score line, said aperture extending to the top panel, whereby the apertures are both vertical and horizontal;
the side panels having two notches in their lower edges and two apertures in the side score lines, said apertures extending to the top panel, whereby the apertures are both vertical and horizontal;
said pack being assembled by inserting the lid on the box, whereby the openings in the end panels of the box and the openings of the lid are coinciding, the notches of the box side panels coincide with the apertures of the lid side panels, and the notches of the box end panels coincide with the apertures of the lid end panels, and the notches of the lid end panels coincide with the apertures of the box end panels;
wherein the improvement comprises that in the pallet airflow moves horizontally and vertically through the packs via horizontal tunnel formed by the apertures of the lid end score lines of a lower pack layer merging with the apertures of the box end fold lines of pack in upper layer, and via vertical tunnel formed by the lid side score line apertures in a lower pack layer merging with the box side fold line apertures of the upper layer.

8. An improved pallet of banana packs for cooling and ripening bananas, comprising a desired number of packs, said packs consisting of a box and a lid
said box having a rectangular bottom panel with an open center, two side panels secured to opposite sides of the bottom panel along side fold lines, and two end panels secured to opposite ends of the bottom panel along end fold lines;
the end panels having two linearly positioned openings in their lower portions and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two linearly positioned openings in their lower portions and a handhold opening;
the top panel having an aperture in center of the end score line;
the side panels having two notches in their lower edges and two apertures in the side score lines, said apertures extending to the top panel, whereby the apertures are both vertical and horizontal;
said pack being assembled by inserting the lid on the box, whereby the openings in the end panels of the box and the openings of the end panel of the lid are coinciding, the notches of the box side panels coincide with the apertures of the lid side panels, and the handhold openings of the box end panels coincide with the handhold openings of the lid end panels;
wherein the improvement comprises that in the pallet airflow moves horizontally and vertically through the packs via horizontal tunnel formed by the apertures of the lid side score lines of a lower pack layer merging with the apertures of the box side fold lines of pack in upper layer, and via vertical tunnel formed by the lid side score line apertures in a lower pack layer merging with the box side fold line apertures of the upper layer.

9. An improved pallet of banana packs for cooling and ripening bananas, comprising a desired number of packs, said packs consisting of a box and a lid,
said box having a rectangular bottom panel with an open center, two side panels secured to opposite sides of the bottom panel along side fold lines, and two end panels secured to opposite ends of the bottom panel along end fold lines;
the end panels having two notches in their upper edges and a handhold opening;
the side panels having two notches in their upper edges and two apertures in the side fold lines, said apertures extending to the bottom panel, whereby the apertures are both vertical and horizontal;
said lid having a rectangular top panel with an open center, two side panels secured to opposite sides of the top panel along side score lines, and two end panels secured to opposite ends of the top panel along end score lines;
the end panels having two apertures at the end score line, said apertures extending to the top panels, whereby the apertures are both vertical and horizontal;
the end panels having also a handhold opening;
the side panels having two notches in their lower edges and two apertures in the side score lines, said apertures extending to the top panel, whereby the apertures are both vertical and horizontal;
said pack being assembled by inserting the lid on the box, whereby the notches of the box side panels coincide with the apertures of the lid side panels, and the handhold openings of the box end panels coincide with the handhold openings of the lid end panels, and the notices of the lid end panel coincide with the apertures of the box end panel;
wherein the improvement comprises that in the pallet airflow moves horizontally and vertically through the packs via horizontal tunnel formed by the apertures of the lid end score lines of a lower pack layer merging with the apertures of the box end fold lines of pack in upper layer, and via vertical tunnel formed by the lid side score line apertures in a lower pack layer merging with the box side fold line apertures of the upper layer.
